(19) United States
(12) Patent Application Publication
(10) Pub. No.: US 2005/0056154 A1
(43) Pub. Date: Mar. 17, 2005

(54) POPCORN APPARATUS

(75) Inventor: Hsiang-Tai Fu, Tainan Hsien (TW)

Correspondence Address: BACON & THOMAS, PLLC, 625 SLATERS LANE, FOURTH FLOOR, ALEXANDRIA, VA, 22314, US

(73) Assignee: CHIN TUNG INDUSTRIAL CO., LTD., Tainan Hsien (TW)

(21) Appl. No.: 10/663,739

(22) Filed: Sep. 17, 2003

(51) Int. Cl. A23L 1/18

(52) U.S. Cl. 99/323.5

(57) ABSTRACT

A popcorn apparatus comprised of a kettle having a contained space inside and a lipped rim along the circumference of the opening; a lid consisting of a first lid member and a second lid member, the first lid member having a latch fixture and a handle mount, with the latch fixture capable of engagement onto the lipped rim of the kettle; a stirring mechanism consisting of a crank rod disposed on the lid and a mixing rod extending into the contained space inside the kettle; a grip handle situated on the handle mount of the lid, the structure enabling the engagement of the latch fixture built into the lid onto the lipped rim of the kettle to secure the lid in position.

### BACKGROUND OF THE INVENTION

1) FIELD OF THE INVENTION

The invention relates to a cooking appliances, specifically a popcorn apparatus that is convenient to operate and does not occupy excessive space during utilization.

2) DESCRIPTION OF THE RELATED ART

Popcorn is a favorite snack that is popular among many people. Conventional household-use, easy-to-operate popcorn appliances provide a container having a top lid frame rod disposed with two elastic insertion elements on an opening at the upper extent, the top lid frame rod having a through-hole penetrating its center, enabling two lid elements to cover the opening at the upper extent of the container, with one side of each lid element respectively hinged to the two sides of the top lid frame rod; a stirring device, one extremity of which is inserted into the through-hole at the center of the top lid frame rod and enmeshed with a bevel gear, the opposite extremity inserted into the container and having a mixing rod; a handle rod, one extremity of which is fixed onto the top lid frame rod such that its rod body is suspended in air and vertically postured; and a crank rod, the rod body of which is inserted into the handle rod rod body and its forward extremity inserted from the handle rod and enmeshed with a bevel gear, said bevel gear enmeshed with the stirring device bevel gear; the outer wall at the anterior extremity of said handle rod consists of screw threads and a fixing screw mount is disposed on the top lid frame rod; when assembled, said handle rod is fastened onto the fixing screw mount and, furthermore, said crank rod is inserted into said handle rod and the fixing screw mount and enmeshed with the bevel gear, such that turning the crank rod drives the stirring device into rotational agitation.

Although such structures provide relatively convenient popcorn making performance in households, since the crank rod is disposed at one extremity of the handle rod and juts horizontally to one side, the person cooking easily hits the crank rod and the handle rod by accident, causing the container to overturn during heating, resulting in burn injuries to the cook; additionally, as the lid elements are inclined when opened, one hand must hold the handle rod and the other hand has to support the lid element, making utilization quite impractical.

### SUMMARY OF THE INVENTION

The objective of this invention herein is to provide a popcorn apparatus which comprised of a kettle having a contained space inside and a lipped rim along the circumference of the opening; a lid consisting of a first lid member and a second lid member, the first lid member having a latch fixture and a handle mount, with the latch fixture capable of engagement onto said lipped rim of said kettle; a stirring mechanism consisting of a crank rod disposed on said lid and a mixing rod extending into the contained space inside the kettle; a grip handle situated on the handle mount of said lid, said structure enabling the engagement of the latch fixture built into said lid onto the lipped rim of the kettle to secure the lid in position.

### BRIEF DESCRIPTION OF THE DRAWINGS

Other features and advantages of the present invention will become apparent in the following detailed description of the preferred embodiments, with reference to the accompanying drawings, in which:

FIG. 1 is a cross-sectional drawing of the invention herein.

FIG. 2 is an orthographic drawing of the invention herein with the grip handle off the lid.

FIG. 3 is a drawing of the second lid handle base when the grip handle is down.

### DETAILED DESCRIPTION OF THE PREFERRED EMBODIMENTS

In the detailed description of the preferred embodiments, it should be noted that similar elements are indicated by the same reference numerals throughout the disclosure.

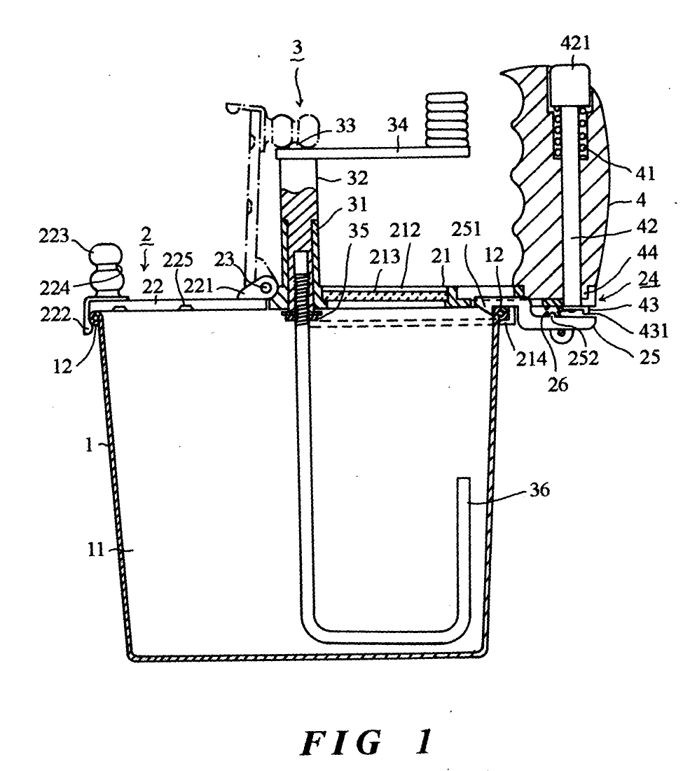

Referring to FIG. 1, the preferred embodiment of the popcorn apparatus invention herein is comprised of:

A kettle 1 having a contained space 11 inside and a lipped rim 12 along the circumference of the opening.

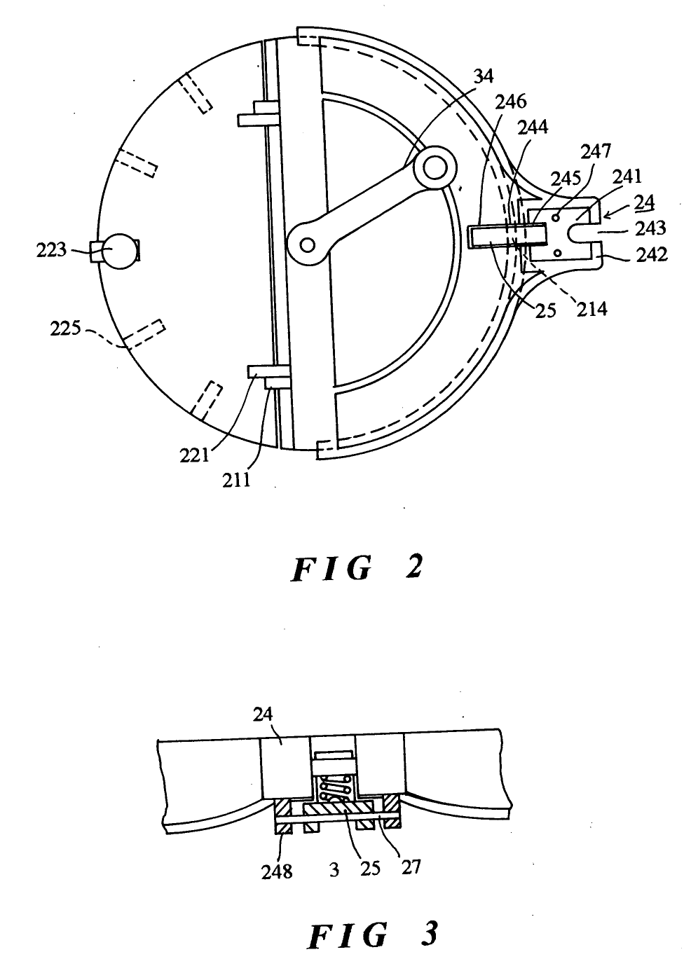

A lid 2 consisting of a semicircular first lid member 21 and second lid member 22, the two linked via a pin 23 to hinge tabs 211 and 221; referring to FIG. 2, the first lid member 21 has a reticulation 212 formed in it and a transparent hood 213 is disposed in said reticulation 212; the first lid member 21 has a slot-shaped latch fixture 214 at its lower extent on the curve of the circumference and a slightly square-shaped handle mount 24 situated at one side of the first lid member 21; an indentation 241 is formed in the center of the handle mount 24 and a square-shaped protrusions 242 jutting from the sides, the handle mount 24 has a breach facing outward in the form of an opening 243 and another catch slot 244 facing the opposite direction of the opening 243, the catch slot 244 consisting of a first catch slot 245 and a second catch slot 246 that straddle two sides of said latch fixture 214; a mounting hole 247 is disposed in the indentation 241; a first latch component 25 is situated at the lower extent of the handle mount 24, its extremity reaching horizontally in a bend to the rear of said catch slot 244 first catch slot 245 and transitioning into an inverted hook 251 that curves and extends into said second catch slot 246, enabling the inverted hook 251 to become situated at the anterior extent of said slot-shaped latch fixture 214 entrance, the inverted hook 251 and the latch fixture 214 both engaged onto said lipped rim 12 along the circumference of said kettle 1, thereby positioning the first lid member 21 on the kettle 1; a spring constituted elastic member 26 is disposed between the first latch component 25 at the lower portion of the handle mount 24 and the handle mount 24, said elastic member 26 guided and positioned by the protruding member 252 on the first latch component 25, enabling said inverted hook 251 to remain engaged against the lipped rim 12 along the circumference of said kettle 1.

Referring to FIG. 3, the first latch component 25 consists of hinge tabs 253 disposed at its two sides that are conjoined to hinge tabs 248 extending downward from the two sides of the handle mount 24 via a pin 27 that is pivotably situated at the lower extent of the handle mount 24; the second lid member 22 has a second latch component 222 at its lower extent on the curve of the circumference, with a knob 223 disposed at the upper extent; a retaining groove 224 is formed on the knob 223 and, furthermore, air holes 225 radiate outward on the second lid member 22 from the lower extent of its cover surface near the curve of the circumference.

A stirring mechanism 3 consisting of a sleeve seat 31 on the upper extent of said first lid member 21 and a tubular shaft 32 movably situated in the sleeve seat 31, there is an obtruding fixing member 33 at one extremity of the tubular shaft 32 as well as a horizontally disposed revolvable crank rod 34, and when the second lid member 22 is raised up to the position of the imaginary line shown in FIG. 1, said knob 223 retaining groove 224 is docked into place on the obtruding fixing member 33 at the upper extent of the stirring mechanism 3 tubular shaft 32; a threaded fastener 35 is installed onto the opposite extremity of the tubular shaft 32 to locate the mixing rod 36 in the contained space 11 inside the kettle 1.

A grip handle 4, its internal section having an actuation rod 42 loaded by an elastic component 41; a press section 421 is formed at one extremity of said actuation rod 42, a check member 43 extends from the opposite, lower extremity of the grip handle 4, and a push section 431 projects from said check member 43; an insertion seat 44 at the lower extent of the grip handle 4 is situated against the handle mount 24 in said first lid member 21.

For packaging and shipping, the grip handle 4 and mixing rod 36 in the stirring mechanism 3 are detached, enabling the removal of the first and the second lid members 21 and 22 of the lid 2 and their placement into the contained space 11 inside the kettle 1, following which the detached grip handle 4 and mixing rod 36 are placed within, thereby minimizing packaging dimensions.

For assembly and utilization, said mixing rod 36 is first screwed into position on the stirring mechanism 3 tubular shaft 32; next, after the press section 421 of the grip handle 4 actuation rod 42 is coupled to the check member 43 at the lower extent of the actuation rod 42, the actuation rod 42 extending downward from the grip handle 4 is moved into the opening 243 ported outward in the first lid member 21 handle mount 24, and then the tension at the actuation rod 42 press section 421 is operatively released, such that the grip handle 4 insertion seat 44 becomes nested in the handle mount 24 indentation 241, and then the lower extent of the grip handle 24 is positioned with threaded fasteners via the mounting holes 247 to the insertion seat 44 to secure the grip handle 4; as entirely situated at the upper end of the kettle 1, the first lid member 21 is pushed level from the kettle 1 circumference outward to the center of the kettle 1 until the first latch component 25 inverted hook 251 moves to the kettle 1 lipped rim 12 such that the lipped rim 12 of the kettle 1 is engaged by said inverted hook 251 and the latch fixture 214, at which time the first lid member 21 is fully positioned.

When taking the whole lid 2 off the kettle 1 is desired, the press section 421 of the grip handle 4 actuation rod 42 is operated such that the actuation rod 42 impels the first latch component 25 and releases it from the engaged state to allow the removal of the lid 2.

As for operation, when popcorn is cooked in the kettle 1, the second lid member 22 second latch component 222 is engaged onto the lipped rim 12 of the kettle, and steam inside the kettle 1 is discharged through the air holes 225 along the circumference of the second lid member 22, the internal situation during the cooking process observable through the transparent hood 213, and turning the crank rod 34 causes the mixing rod 36 to shuffle the corn; when the popcorn is cooked and ready to serve, the second lid member 22 knob 223 is utilized to lift the second lid member 22 such that the retaining groove 224 of the knob 223 docks into place on the fixing member 33 at the upper extent of the crank rod 34 to facilitate the pouring out operation.

In summation of the foregoing section, the preferred embodiment of the invention herein minimizes packaging material dimensions and, furthermore, the design takes ergonomic considerations into account, including the operation of the crank rod 34 and its non-horizontal projection during usage that averts overturning due to accidental impact, thereby reducing the cost of the present invention and, furthermore, providing for superior safety; the observation allowed by the design enables easier control over cooking; and the docking into position when the second lid member 22 is raised increases operating convenience.

While the present invention has been described in connection with what is considered the most practical and preferred embodiments, it is understood that the invention herein is not limited to the disclosed embodiments but is intended to cover various arrangements included within the spirit and the scope of the broadest interpretations and equivalent arrangements.

1. A popcorn apparatus comprising:
a kettle having a contained space inside and a lipped rim along the circumference of the opening;
a lid consisting of a first lid member and a second lid member; the first lid member has a latch fixture and a handle mount; said latch fixture capable of engagement onto said lipped rim of said kettle;
a stirring mechanism consisting of a crank rod disposed on said lid and a mixing rod extending into said contained space inside said kettle;
a grip handle situated on said handle mount of said lid, wherein said grip handle has an internally disposed actuation rod and a press section is formed on said actuation rod, and the opposite extremity extends downward from said grip handle; said handle mount has a first latch component; said latch fixture on said lid and said first latch component both engage said lipped rim of said kettle, thereby securing said lid into position; said press section of said grip handle actuation rod is operated such that said actuation rod impels said first latch component and releases it from the engaged state to allow the removal of said lid; and
wherein the engagement of said latch fixture built into said lid onto said lipped rim of said kettle secures said lid in position.

2. (canceled).

3. A popcorn apparatus as claimed in claim 1, wherein said second lid member has a second latch component.

4. (canceled).

5. A popcorn apparatus as claimed in claim 1, wherein said first lid member has a reticulation formed in it and a transparent hood is disposed in said reticulation.

6. A popcorn apparatus as claimed in claim 1, wherein said handle mount has an indentation formed at its center and square-shaped protrusions jutting from its outer sides.

7. A popcorn apparatus as claimed in claim 1, wherein said handle mount has a breach facing outward in the form of an opening and another catch slot facing the opposite direction of said opening.

8. A popcorn apparatus as claimed in claim 7, wherein said handle mount catch slot consists of a first catch slot and a second catch slot that straddle two sides of said latch fixture; one extremity of said first latch component reaches horizontally in a bend to the rear of said first catch slot, transitioning into an inverted hook that curves and extends into said second catch slot, enabling said inverted hook to become situated at the anterior extent of the entrance of said slot-shaped latch fixture, said inverted hook and said latch fixture both engaged onto said lipped rim along the circumference of said kettle.

9. A popcorn apparatus as claimed in claim 1, wherein disposed between said first latch component at the lower portion of said handle mount and said handle mount is an elastic member.

10. A popcorn apparatus as claimed in claim 9, wherein said elastic member is guided and positioned by a protruding member on said first latch component.

11. A popcorn apparatus as claimed in claim 1, wherein said first latch component consists of hinge tabs disposed at its two sides that are conjoined to hinge tabs extending downward from the two sides of said handle mount via a pin that is pivotably situated at the lower extent of said handle mount.

12. A popcorn apparatus as claimed in claim 1, wherein said second latch component of said second lid member has a knob disposed on its upper extent.

13. A popcorn apparatus as claimed in claim 12, wherein said knob has retaining groove formed on it.

14. A popcorn apparatus as claimed in claim 1, wherein said second lid member has air holes radiating outward from the lower extent of its cover surface near the curve of the circumference.

15. A popcorn apparatus as claimed in claim 1, wherein said stirring mechanism consists of a sleeve seat on the upper extent of said first lid member and a tubular shaft movably situated in said sleeve seat, and there is the horizontally disposed revolvable said crank rod at one extremity of said tubular shaft and said mixing rod fastened to the other extremity.

16. A popcorn apparatus as claimed in claim 15, wherein said second lid member can be raised up such that said knob retaining groove is docked into place on said stirring mechanism tubular shaft.

17. A popcorn apparatus as claimed in claim 16, wherein said knob is by means of its said retaining groove docked into place on an obtruding fixing member of said tubular shaft.

18. A popcorn apparatus as claimed in claim 1, wherein said actuation rod inside said grip handle is loaded by an elastic component inside said grip handle.

19. A popcorn apparatus as claimed in claim 1, wherein a check member extends from the lower extremity of said grip handle and a push section projects from one side of said check member.

20. A popcorn apparatus as claimed in claim 1, wherein said grip handle has an insertion seat at its lower extent that is situated against said handle mount in said first lid member.
